(19) United States
(12) Patent Application Publication
(10) Pub. No.: US 2005/0004807 A1
(43) Pub. Date: Jan. 6, 2005

(54) System and method of scholarship and financial aid matching

(76) Inventors: Donald Fenstermaker, Glendale, AZ (US); Dennis Eaglestone, Phoenix, AZ (US); David Fenstermaker, Glendale, AZ (US); Wilson Sheih, Scottsdale, AZ (US)

Correspondence Address: STEPTOE & JOHNSON LLP;Stuart T.F. Huang - Box USPTO, 1330 Connecticut Avenue, NW, Washington, DC, 20036, US

(21) Appl. No.: 10/612,403

(22) Filed: Jul. 3, 2003

(51) Int. Cl. G06F 17/60

(52) U.S. Cl. 705/1; 705/26; 705/10

(57) ABSTRACT

A system and method of matching students with scholarship, financial aid, or loan information is presented. Customers, such as universities or colleges, may submit information to be presented in any, or a combination, of a state and a local database. Students searching for scholarships, grants, awards, loans, and financial aid information through a web site associated with a particular university may receive results that are particularized to that university as well as results that are national in scope.

### BACKGROUND OF THE INVENTION

1. Field of the Invention

The invention relates to a system and method for searching for scholarships and other financial assistance for education. More particularly, the invention relates to a system and method for searching for scholarships through a network interface.

2. Discussion of Background Information

Students entering universities typically face a bewildering search for options for financing their education. It is generally difficult for students (or their parents or other representatives) to locate and obtain scholarships, grants, awards, loans, or financial aid. Books that collect limited amounts of such data exist. However, books are static and cannot provide up-to-the-minute information about student finance options. Moreover, books are typically incomplete in that no single book contains entries that may be submitted from any scholarship-granting agency that wishes to publicize a new scholarship. Students are therefore left with the prospect of searching through a multitude of incomplete and out-of-date static paper information sources in order to locate funding.

In registering for a scholarship, students will typically fill out request forms with accurate and honest data in an effort to obtain the best possible chances of receiving that award. Thus, student information submitted in scholarships tends to be highly-reliable and intensely personal. There has never been an effective way to collect scholarship request information in a manner that allows collection of such user data from a multitude of scholarship applications. Thus, a rich source of valuable demographic data has remained virtually untapped.

### SUMMARY OF THE INVENTION

According to an embodiment of the invention, an on-line method of matching students with scholarships is provided. A pool of databases is provided, the pool of databases comprising one or more databases. The pool of databases is logically partitioned into at least a national section and at least one local section, and contains entries from a plurality of customers. A first request formed by a first customer to insert an entry identifying a scholarship into one or more of the national section and a first local section is received through a computer network. The entry is inserted into the pool of databases consistent with the first request. A second request to search for scholarship information is received, the second request sent by a user through a web site associated with the first customer. Scholarship information is searched for consistent with the second request, a scope of the search having a dependency on at least the web site associated with the first customer, the dependency resulting in the scope of the search including the first local section associated with the first customer. A third request to search for scholarship information is received, the third request sent by the user through a web site associated with a second customer. Scholarship information is searched for consistent with the third request, a scope of the search having a dependency on at least the web site associated with the second customer, the dependency resulting in the scope of the search excluding the first local section associated with the first customer. The search for scholarship information consistent with the second request preferably produces any match between a student and scholarship information.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIGS. 1A and 1B are flow charts depicting user search processes;

FIG. 2 is a depiction of a search engine embodiment home page;

FIG. 3 is a flow chart depicting a portion of a scholarship search process;

FIG. 4 is a flow chart depicting student profile handling;

FIG. 5 is schematic diagram depicting multi-profile support;

FIGS. 6A-6D are flowcharts depicting administrative processes;

FIG. 7 presents schematic diagrams of a granting agency's administrative process pages;

FIG. 8 is a schematic diagram depicting a scholarship data structure;

FIG. 9 is a schematic diagram depicting scholarship record access permissions; and

FIG. 10 is a schematic diagram overview of parties' interaction with a scholarship search engine embodiment.

### DETAILED DESCRIPTION OF THE EXEMPLARY EMBODIMENT

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

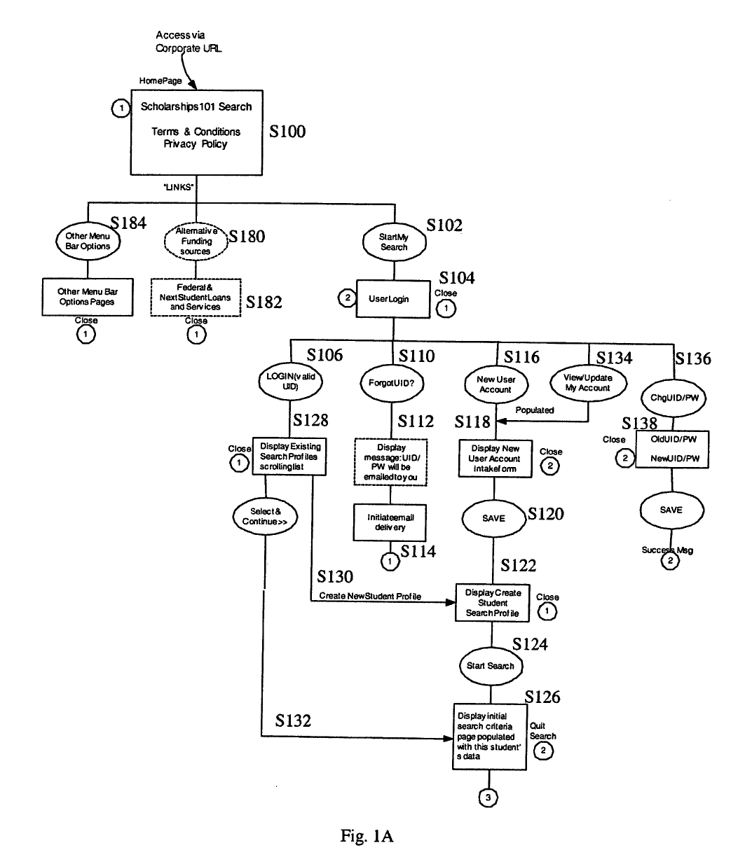

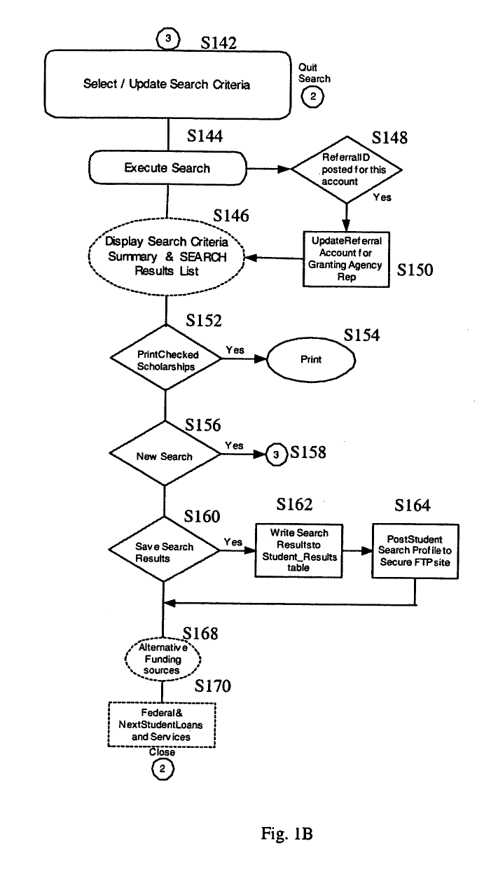

FIGS. 1A and 1B are flow charts depicting a user search process. A user, such as a student or a student's representative (e.g., a parent), begins at step S100 by accessing a homepage of a scholarship search engine embodiment. As used herein, the term “scholarship” includes, by way of non-limiting example, scholarships, grants, awards, loans, financial aid, and the like. From the homepage, the user may choose among various options by following links. One option available from the home page is searching for scholarships, discussed further immediately below. Another option available from the homepage is searching for alternate funding sources at step S180. Alternate funding sources may include federal or private loans at step S182, such as loans provided by the host of the scholarship search engine embodiment. Other options available from the scholarship search engine home page may be accessed, by way of non-limiting example, on a menu bar at step S184. The user is directed back to the scholarship search engine home page upon closing any of the options linked therefrom.

Before conducting a search for scholarships, the user is directed to a login page at step S104, which requires a user identification (ID) and password. If in possession of a valid account, the user may login at step S106. If the user already has an account but has forgotten the password or ID, he may request that it be emailed to him at step S110. The system responds to such a request by displaying a message indicating that the password or ID have been emailed at step S112 and emailing the same to the user at step S114. If the user does not already have an account, he may request one at step S116. The system responds to a request for a new account by directing the user to a New User Account Intake Form at step S118. If the user closes this form, the system returns the user to the login screen, S104. Otherwise, the user proceeds to fill out the form, which is then saved by the system at step S120. The system then allows the user to create a student search profile at step S122. If this screen is closed, the system returns control to the homepage, S100. Otherwise, the user may proceed to search for available financial aid or scholarships at step S124. The system begins this process at step S126 by displaying an initial search criteria page populated with the student's data. If the user closes this screen, his browser will be directed to login page at step S104.

If the user logs in using a pre-existing account at step S106, he will be directed at step S128 to a page containing a display of existing search profiles. Existing search profiles are preferably presented in a scrolling list. Closing this page directs the user's browser to home page at step S100. Otherwise, the user may create a new profile at step S130, or start a search at step S132. If the user chooses to create a new profile, his browser is directed to step S122. If the user chooses to start a search, his browser is directed to step S126.

From the user login page at step S104, the user may choose to update an existing account or change account parameters. If the user chooses to update or view an existing account at step S134, his browser will be directed to a New User Account Intake Form with the fields already populated with existing account information at step S118. The user may change account parameters at step S136. From there, the user's browser is directed to a Change Password/ID page S138. If the user closes this page, his browser will be directed back to login page S104. Otherwise, the new user account parameters are saved at step S140, a success message is displayed, and the user's browser is returned to login page at step S104.

Details of a student search commenced at step S124 or S126 are discussed presently in reference to FIG. 1B. Continuing from step S126 of FIG. 1A, a user may select or update search criteria at step S142. Quitting this page returns the user's browser to the login page at S104. Once the user selects a search criteria, the search begins at step S144. The process checks whether a referral ID is associated with the account in question at step S148. If such an ID exists, the process is directed to update the referral account for the granting agency representative S150. Otherwise, the search proceeds and the results are displayed to the user, preferably in list format, at step S146. At step S152, the user has the option of selecting scholarships from the results list to be printed at step S154 by checking boxes next to the selected items. The user may request a new search at step S156. Selecting a new search returns the user to step S142 via step S158. The user may save his search results at step S160. Activating this choice causes the system to write the search results to a table at step S162 and post the search results to a secure FTP site at step S164. The search process concludes by offering to direct the user to search for alternate funding sources at step S168 or to search for federal or private loans (which may be sponsored by the search engine provider) at step S170.

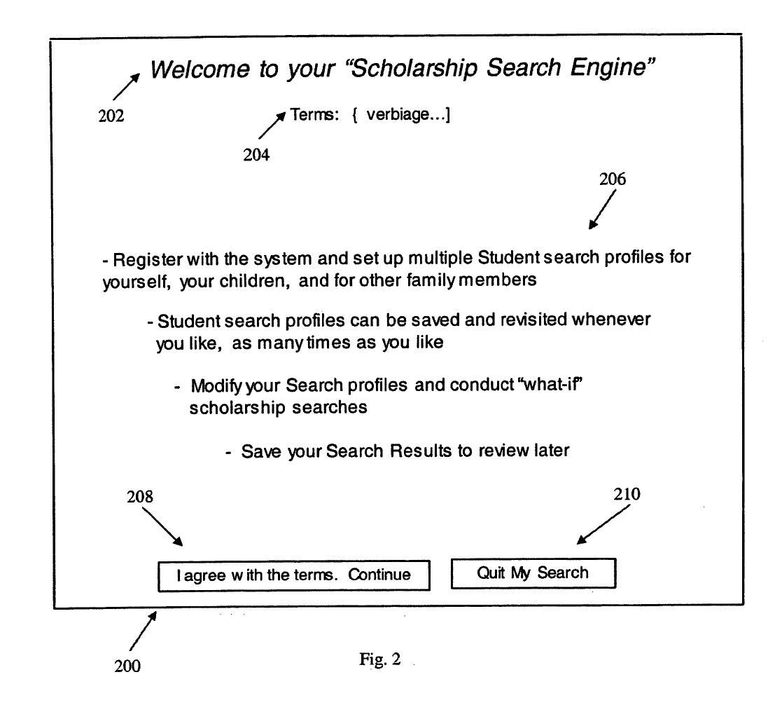

FIG. 2 is a depiction of an exemplary scholarship search engine embodiment with a home page 200. Home page 200 includes a banner identification 202, preferably at the top of the page, and a recital of the terms and conditions 204 for using the scholarship search engine. Home page 200 also preferably includes descriptions of the services available from home page 200, as well as descriptions of the benefits 206 of using that particular scholarship search engine embodiment. Buttons 208, 210 allow the user to choose between agreeing to the terms and proceeding to the search 208, or quitting 210.

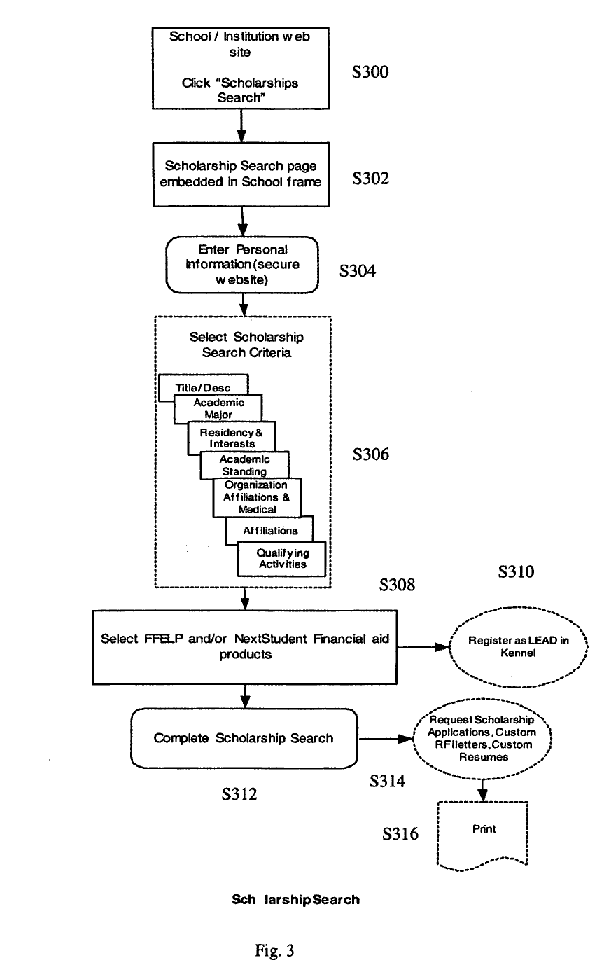

FIG. 3 is a flow chart depicting a portion of a scholarship search process as hosted or otherwise sponsored by an institution such as a university. The process begins at step S300 at the institution's own web site. From there, a user may activate a link to a scholarship search. The user's browser is directed to a scholarship search engine embodiment embedded in the institution's frame at step S302. The user may then enter personal information through a secure website at step S304. Information entered by the user at step S304 and considered by the search engine embodiment at step S306 includes, by way of non-limiting example: the student's academic major, the student's residency (country, state, and county), the student's interests, the student's academic standing, organizations or affiliations of the student, the student's religion, the student's athletic activities, the student's race and ethnicity, the student's physical or mental handicaps (if any), the student's employment, other qualifying activities, and the title or description of the scholarship.

The search is performed according to search algorithms dependent on the entered criteria. The actual algorithms used, apart from their arguments, parameters, inputs, and results, are known to those of ordinary skill in the art. At step S308, the user may select any, or a combination, of Federal Family Education Loan Program (FFELP) scholarships and search-engine-provider financial aid products. If the user indicates interest, at step S310 the process registers the profile under consideration as a lead, that is, as someone who desires information and who may be contacted for possible business. The system overseers may pay a fee to granting agencies in return for each student profile that comprises a lead. Once the scholarship search is complete, step S312, the user may request scholarship applications, develop custom request for information letters, or form custom resumes at step S314. At step S316, the user may print the papers requested, developed, or formed at step S314.

The system overseers may gather personal information submitted by the student at step S304 together with similarly-submitted information from other students to form a database of student demographic information. Due to the student's desire to obtain scholarships, this information is likely to be highly reliable. Information in such a demographics database may include all of the categories of information submitted at step S304. A suitable disclaimer or notice to the student that such information may be provided to third parties is preferably contained on the web page through which the search is conducted. The demographics database may be searchable by any parameter, including, but not limited to, any of the categories of information submitted at step S304.

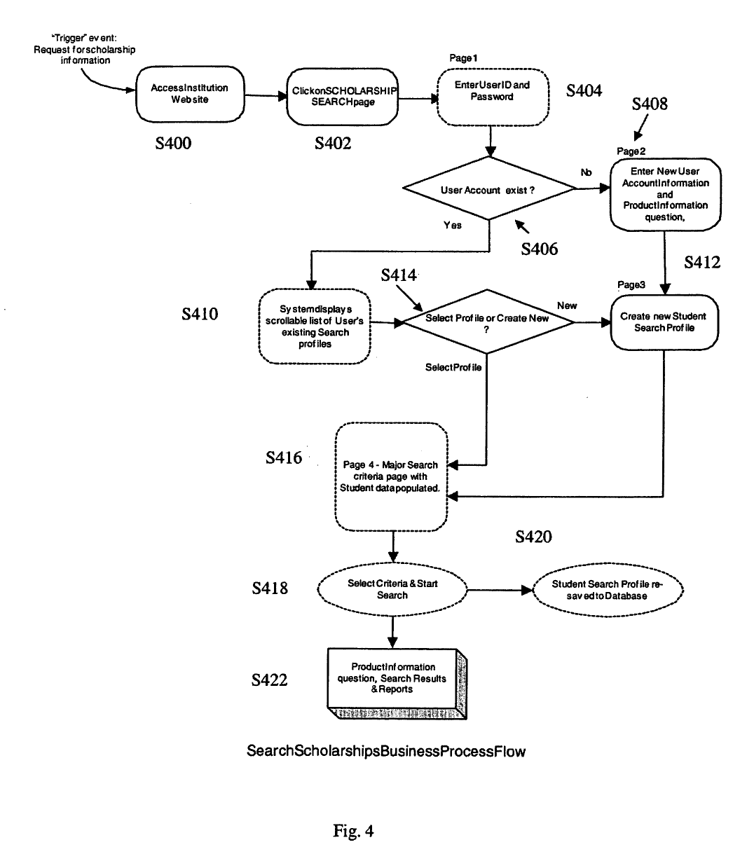

FIG. 4 is a flow chart depicting student profile set-up and handling. Note that a single student may have multiple profiles, and that a user searching for scholarships may be different from the student for whom they are searching. Once a user accesses an institution's web site at step S400 and clicks on the link to the scholarship at step S402, the user is prompted to enter an ID and password at step S404. The system next determines whether a user account already exists at step S406. If no account for that user exists, the process branches at step S406 to provide a screen that allows the user to set up an account at step S408. From there, the user may create a new student search profile at step S412. Also at step S408, if the institution desires it, the user is asked whether he desires information on other financial instruments besides scholarships, grants, and awards. If the user already has an account, then the process branches to step S410, which causes the system to display a scrollable list of existing search profiles. The user is prompted at step S414 to select an existing student profile or create a new one. If the user decides to create a new profile, the system directs the user's browser to join the process at step S412, where the user may create a new profile. Whether the user creates a new profile after setting up a new account at step S408, creates a new profile after accessing the system using an existing account, or selects an existing profile at step S414, the process proceeds to step S416 where the system presents the user with a search criteria page having data populated from the student profile under consideration. The process next selects the appropriate search criteria and commences the search at step S418. The student profile is stored on a database at step S420, and the search results and any additional information requested at step S408 are conveyed to the user at step S422.

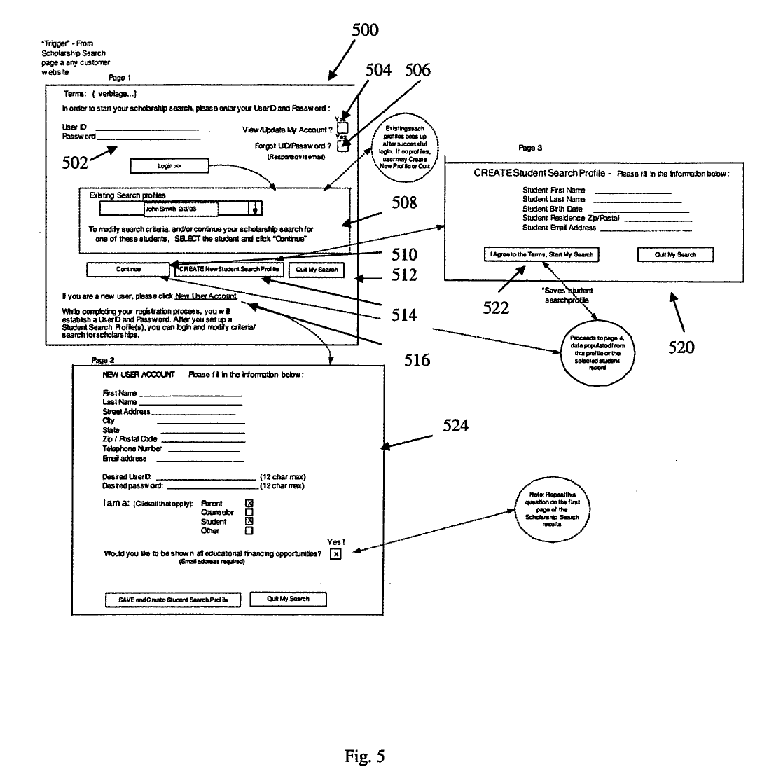

FIG. 5 is schematic diagram depicting multi-profile support. A login screen 500 includes prompts 502 for user ID and password. Login screen 500 also includes a field 506 indicating that the user has forgotten his password and requesting that it to be emailed to him, and a field 504 indicating that the user wishes to update his account. Once the user logs in, login screen 500 alters its appearance to include a pop-up scrollable list 508 of existing student profiles, from which the user may select a student profile for editing or other actions. Button 510 allows users to continue on to the search criteria page having data populated from the student profile being edited. Button 514 allows users to create new student profiles. Upon activation, button 514 directs the user's browser to page 520, which includes fields for the user to enter student information. From page 520, the user may continue on to the criteria page having data populated from the student profile being edited by activating button 522. Login screen also includes a button 512 allowing a user to quit the search.

For new users wishing to create a new account, login screen includes link 516, which directs the user's browser to new user account page 524. New account page 524 includes fields for a student's name, address, telephone number email address, desired user ID, desired password, and identification as one or more of a parent, student, councilor, or “other” relation to the student. New account page 524 also includes a check box with the designation, “Would you like to be shown all educational financing opportunities?” To exit new account page 524, users may activate either a button marked, “SAVE and Create Student Search Profile,” or a button marked “Quit My Search.”

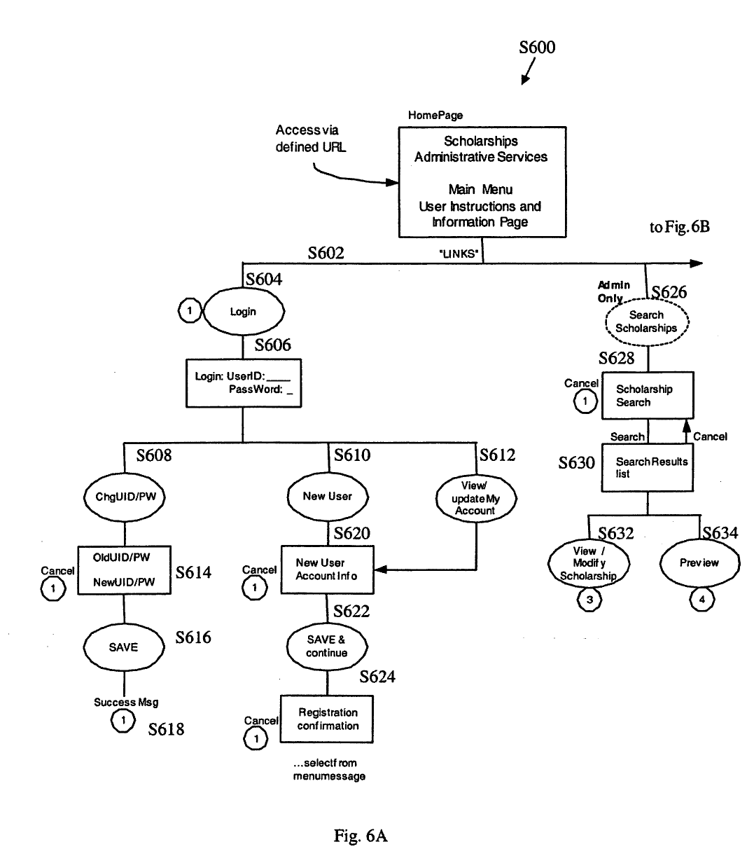

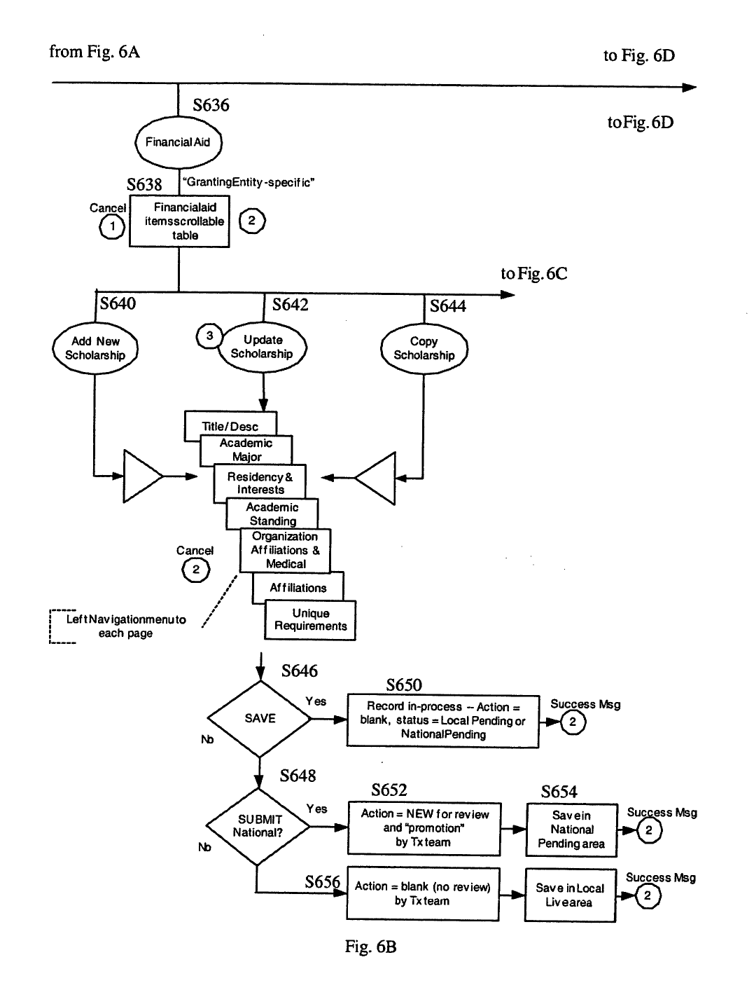

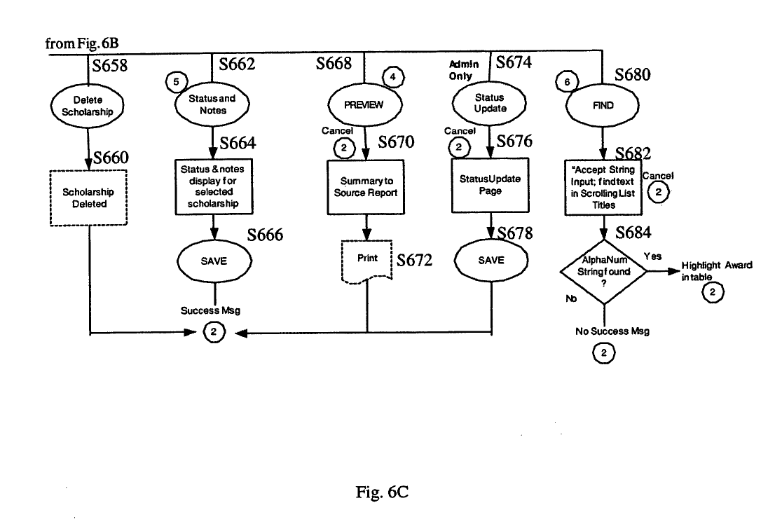

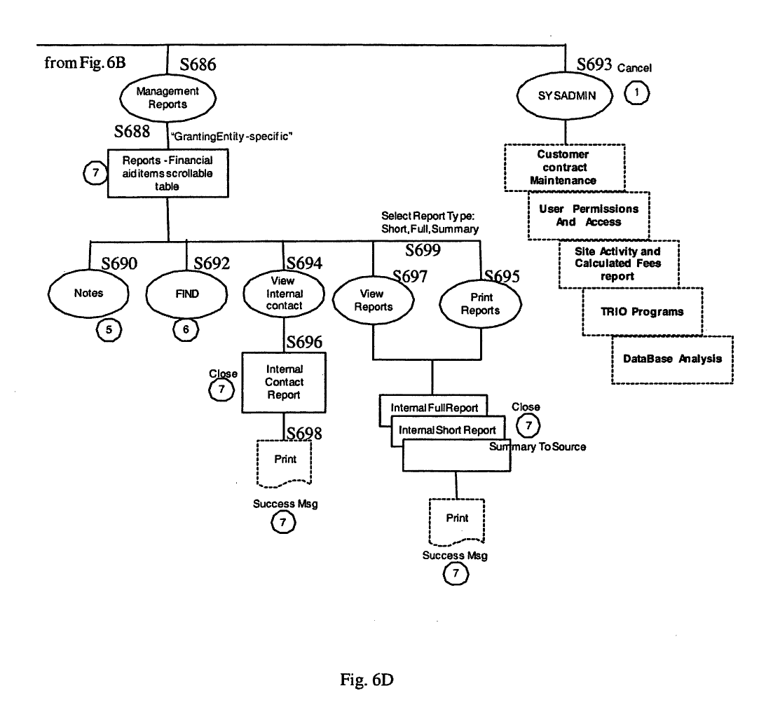

FIGS. 6A-6D are flowcharts depicting administrative processes. From the main administrative page at step S600 of FIG. 6A, scholarship administrators may select from a variety of options. Branch S602 constitutes the administrator login process. Branch S602 therefore includes a login selection step S604 followed by a login screen step S606. After the administrator logs in, he may choose among options including changing one or both of his user ID and password (step S608), creating a new administrative account (step S610), or viewing/updating an existing administrative account (step S612). If the administrator chooses to change an ID and password, he proceeds to enter his old user ID and password and desired new user ID and password at step S614. Exiting this step returns the administrator's browser to login selection step S604. Once the administrator's new ID and password have been saved at step S616, the system issues a “success” message and returns control to login selection step S604. If the administrator chooses to create a new administrative account by selecting step S610, the system proceeds to step S620 where new account data are gathered. If this step is cancelled, control is returned to login selection step S604. Once new administrative account data are gathered, the system saves the data at step S622, sends a registration confirmation at step S624, and returns control to login selection step S604. An administrator selecting to view or update an existing administrative account at step S612 is directed to step S620 where fields are populated with data from that account.

An administrator may choose branch S626 to search for scholarships as a user would. Selecting branch S626 directs the administrator's browser to a scholarship search page at step S628. Canceling this step returns the administrator's browser to login step S604. Search results are presented to the administrator at step S630, preferably in scrollable-list form. Canceling this step returns the administrator's browser to the previous step S628. Once the administrator views the search results, he may elect to view or modify the scholarship entries or preview associated papers. Selecting step S632 to view or modify the scholarship entries directs the user's browser to step S642 of FIG. 6B, whereas selecting step S634 to preview associated papers directs the user's browser to step S668 of FIG. 6C, both of which are discussed further below in reference to those figures.

Description of administrative processes is continued in reference to FIG. 6B. From the main administrative menu at step S600, the administrator may choose to administer scholarship entries by selecting branch S636. The system responds by presenting a list of scholarship entries that are specific to the granting agency associated with that administrator at step S638. These entries are preferably presented in scrollable-list form, and one such entry may be selected by the administrator at this step. If this selection is cancelled, control is returned at login selection step S604. The administrator may take a variety of actions with regard to the scholarship entries. By selecting steps S640, S642, S644, the administrator may add a new scholarship, update an existing selected scholarship, or copy a selected scholarship to represent a new entry, respectively. Each of these choices allows the administrator to modify scholarship fields, including fields for the title and description of the scholarship, an associated academic major, student residency requirements, student academic standing requirements, organizational affiliations, student medical requirements, other affiliations, and other unique student requirements. Canceling any of these steps directs the administrator's browser to step S638. The system gives the administrator the opportunity to save any changes or modifications to the scholarship entry at step S646, and submit the scholarship entry for viewing at step S648.

The database (which may be one central database or a collection of physically interrelated databases) for the scholarship search engine is accordingly logically partitioned into local scholarship entries and national scholarship entries. The phrase “logical partition” and similar phrases are meant to refer to any technique for distinguishing entries from other entries, including, but not limited to, flags, pointers, physical separation, and spreadsheet categories.

Local scholarship entries refer to entries designated as accessible by a limited audience or through limited pathways. By way of non-limiting example, a school could restrict a particular scholarship as accessible only by searching on that school's website. In another example, the school authorizes access through its web-site or web-sites of related schools, such as a state school system. In yet another example, the methodology could be one of exclusion rather than inclusion, in which specific schools are designated as unauthorized to access that data from their websites. Such authorizations could be added during entry of the scholarships into the database or during subsequent processing or maintenance.

In contrast, national scholarship entries refer to entries that are unrestricted, in that they can be searched through any appropriate web-site.

For each scholarship entry, the administrator may specify the types of searches that may yield that scholarship entry in their search result set. Searches may be of local scope, of national scope, or both. The administrator may restrict search results for searches conducted from a scholarship search engine embodiment that is hosted by a particular institution, such as a university, to local scholarships only. The scope of such searches may be restricted to scholarships whose granting agency is associated with, or resident in, the state in which the institution is located, or to scholarships that are only available to students that attend that particular institution. The scope of local searches may include scholarships associated with other, related, schools or institutions.

At steps S646 and S648 of FIG. 6B, the system allows the administrator associated with a particular scholarship entry to choose the searches in which the scholarship may appear. At step 646A, the administrator may choose to save a scholarship entry for appearance in search result sets of searches of local scope. If the administrator chooses to save a scholarship entry at this stage, the scholarship entry will be designated “local pending” at step S650, the system issues a success message at step S638, and returns to step S636. The scholarship entry will accordingly be sent to a local pending area of the scholarship search engine database. Once the system overseers approve such a scholarship entry, it will be released to the “local live” portion of the scholarship search engine database such that it may appear in searches of local scope conducted by users. If the user chooses not to save the scholarship entry at step S646, the process proceeds to inquire as to whether the entry will be submitted to the national portion of the scholarship database at step S648. If the administrator chooses to save the scholarship entry in the national portion of the database, the scholarship entry will be designated “national pending” at step S652 and saved in the national pending portion of the scholarship search engine database at step S654. Once the system overseers approve the scholarship, it will be transferred to the “national live” portion of the database and be accessible to searching users. If the administrator chooses not to save the scholarship entry at step S648, the system overseers will not examine the scholarship entry (step S656), and it will be entered into the “local live” portion of the database. After the scholarship entry is saved in either the national pending or local live portions of the database, step S684, the system will present a success message to the administrator and transfer the control process to step S638.

FIG. 6C depicts further administrative processes available for each scholarship entry selected from step S638 of FIG. 6B. The administrator may choose to delete a selected scholarship via step S658. The system responds by deleting the scholarship at step S660 and returning the process to step S638 of FIG. 6B. The administrator may request the status of the selected scholarship and display related notes by choosing step S662. The system will accordingly provide the status of the scholarship entry and any accompanying notes to the administrator in step S664. The administrator may then save any updated notes at step S666, after which the process returns to step S638 of FIG. 6B. Another option available to the administrator is previewing the scholarship at step S668, which causes the system to provide a summary of the scholarship selected at step S638. The summary may be printed or viewed on-screen; after either choice, the process will return to step S638. The administrator may also choose to view a status update of the scholarship entry through step S674. Selecting this option causes the system to direct the administrator's browser to the status update page, after which the administrator may save the results and return to step S638 or return to step S638 directly. The system also provides a search functionality to the administrator. Selecting step S680 will direct the administrator's browser to a page in which a string may be input. The system will locate and highlight the string in the scrolling list of step S638, and subsequently return control to step S638.

FIG. 6D depicts still further administrative processes available from the administrative home page of step S600. In particular, FIG. 6D includes a branch S686 for viewing various management reports associated with the scholarships. An administrator selecting the management reports branch at step S686 will have his browser directed to a scrollable list containing scholarship entries at step S688. Once the administrator selects a scholarship from the scrollable list, he may choose from several options. The administrator may choose to view notes regarding the selected scholarship at step S690, the selection of which will direct the administrator's browser to step S662 of FIG. 6C. The administrator may choose to search the scholarship list by selecting step S692, which will direct his browser to step S680 of FIG. 6C. The administrator may also choose to view an internal contact report at step S694, which contains information by which the system overseers may contact the scholarship provider. With this selection, the administrator may view the internal contact report at step S696 or print the internal contact report at step S698. Closing either option will direct the administrator's browser to step S686. The administrator may select at step S699 either a short management report, a full management report, or a management report summary. The administrator may choose to view (step S697) or print (step S695) the selected management report, after which the process returns to step S686. Administrators may also choose to engage in systems administrative tasks by selecting step S693. From this step, the administrator may, by way of non-limiting example, maintain customer contracts, edit user permissions and access, view a site activity report and calculated fees, edit Federal TRIO program documents, or analyze database entries.

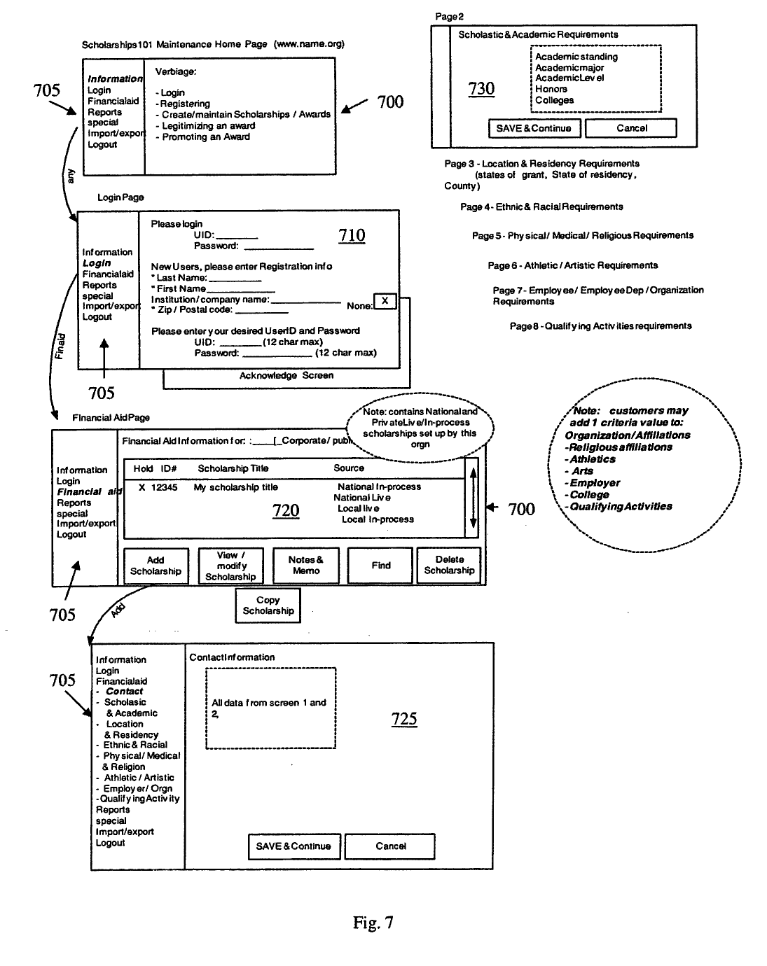

FIG. 7 presents schematic diagrams of a granting agency's administrative process pages. In particular, main administrative home page 700 contains a link to a login page for administrators of granting agencies, a link to a registration page for the administrators of new granting agencies, a link to create or maintain scholarships, a link to post a scholarship, and a link to promote an award from pending or in-process to live or active status. Administrative home page also includes a menu tree 705. Menu tree 705 contains multiple links to pages that may be accessed directly. More particularly, menu tree 705 contains links directly to the login page 710, the scholarship page 720, a management reports page, a special page, an import/export page, and a logout page. Menu tree 705 preferably persists among the pages to which it links. That is, menu tree 705 is preferably present on all pages that contain a link on menu tree 705 (e.g., login page, scholarship page, management reports pages, special page, import/export page, and logout page).

FIG. 7 also depicts a login page 710 for administrators. Activating any of the menu links from administrative home page 700 will direct the associated browser first to login page 710. Login page 710 includes a login portion including a user ID field and a password field for current administrative users. Also present on login page 710 are a new user registration portion including fields for first and last names, an institution (or company) name, a zip code, and desired user ID and password. FIG. 7 also depicts a scholarship page 720. Financial aid page 720 includes a scrollable list containing titles of all scholarships that the associated granting agency administers. Each such scholarship is identified as either national or local and either “live” or “in-process.” Scholarship page includes buttons for adding a scholarship, viewing or modifying a selected scholarship, accessing notes and memoranda, accessing search capabilities, copying a selected scholarship, and deleting a selected scholarship.

FIG. 7 also depicts pages of an add-scholarship suite. The add-scholarship page suite includes pages for specifying, for each scholarship: contact information, scholastic and academic requirements, location and residency requirements, ethnic or racial requirements, physical, racial, or religious requirements, athletic or artistic requirements, employer or organization requirements, and qualifying activity requirements. Each of these pages is accessible directly from any page containing menu tree 705 by expanding the appropriate scholarship link. Each of these pages also includes buttons marked “save and continue” and “cancel.” Contact information page 725 of the add-scholarship suite includes fields for displaying and editing contact information associated with the scholarship being added. Scholastic and academic requirements page 730 includes fields to specify, by way of non-limiting example, required academic standing, academic major, academic level, honors, and colleges.

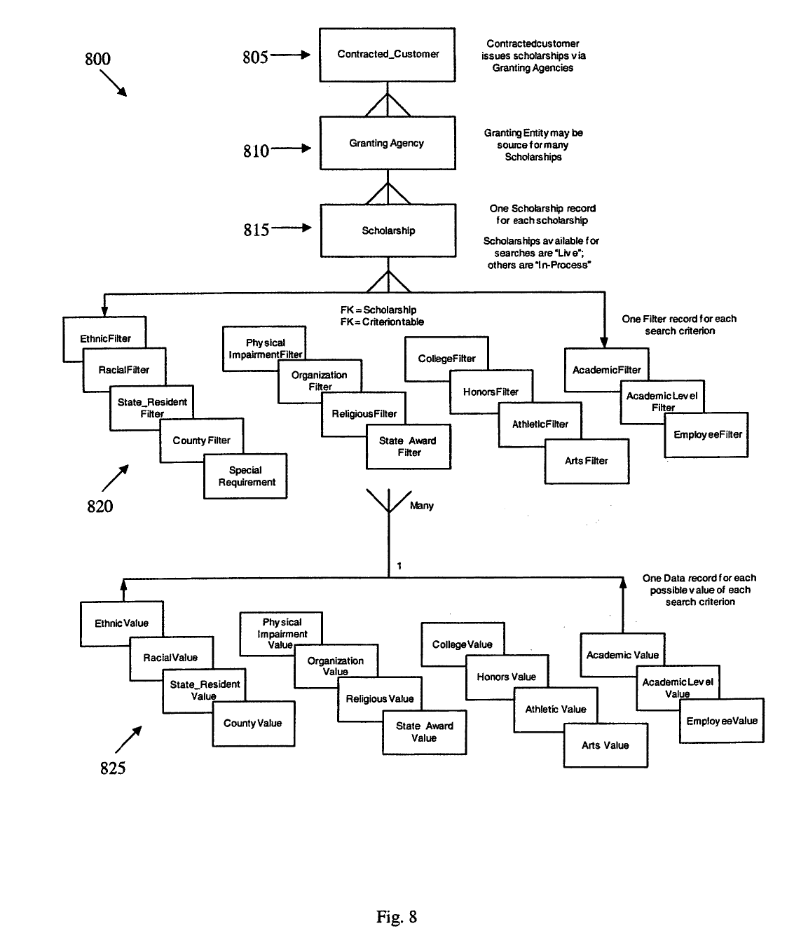

FIG. 8 is a schematic diagram depicting a scholarship data structure 800. The schematic diagram illustrates that each scholarship entry data structure includes a hierarchy of database records. In particular, each scholarship data structure 800 includes a contracted customer record 805, which identifies the party that issues the scholarship through the granting agency. Accordingly, each scholarship data structure 800 also includes a record of the granting agency 810 and a scholarship record 815. Each scholarship data structure further includes filters 820 (i.e., requirements) regarding the following characteristics: ethnicity, race, state of residency, county, special requirements, physical impairment, organization affiliations, religion, state award, college, honors, athletics, arts, academics, academic level, and employee. For each filter in a particular scholarship data structure, the scholarship data structure further contains a value 825 for that filter.

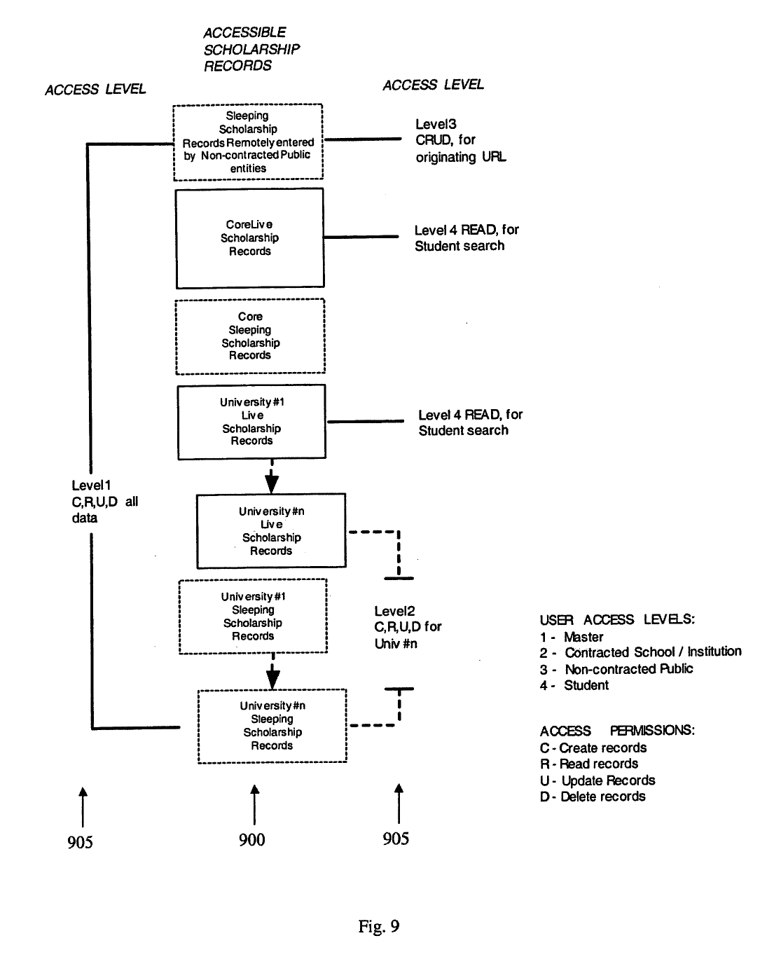

FIG. 9 is a schematic diagram depicting scholarship record access permission. For each scholarship record 900, an access level 905 is associated. Access levels identified in FIG. 9 include: master, contracted institution, non-contracted public, and student or user. Each access level and scholarship record also has an associated access permission. Access permissions are identified as the ability to: create records, read records, update records, and delete records. As depicted by FIG. 9, those with master access level may create, read, update, and delete all scholarship records. Contracted institutions may create, read, update, and delete both live scholarship records and in-process (i.e., pending or “sleeping”) scholarship records associated with that institution. Non-contracted public may create, read, update, and delete in-process scholarship records that they themselves have entered. Students may read live scholarship records, both national and local.

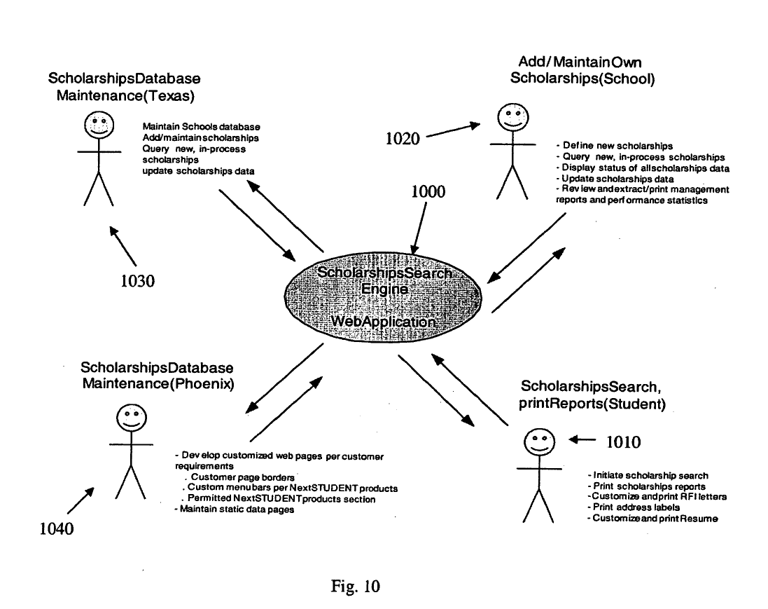

FIG. 10 is a schematic diagram overview of parties' interaction with a scholarship search engine embodiment 1000. Students 1010 (or, in general, users representing students) may interact with scholarship search engine embodiment 1000 by searching for scholarships and receiving and printing search results. More particularly, students and other users may initiate a scholarship search, maintain one or more student profiles, print scholarship reports, customize and print request for information letters, print address labels, and customize and print resumes. Institutions 1020, such as universities, may maintain and post scholarships, define new scholarships, edit and check the status of pending scholarships, update scholarship data, and review, extract, and print management reports and performance statistics. The system overseers 1030, 1040 maintain the scholarship database and promote or legitimize pending scholarships submitted by institutions or granting agencies to live status such that they may be viewed by searching students and other users. By way of non-limiting example, the system overseers are depicted in FIG. 10 as comprising two groups 1030, 1040. However, one or more than two groups may also be used. Group 1030 generally maintains scholarship records. More particularly, group 1030 maintains schools databases, adds and maintains scholarships, moderates submissions by screening scholarships and promoting them from pending to live status if warranted, and updates scholarship data. Group 1040 generally performs web page maintenance. That is, group 1040 develops customized web pages per customer requirements (e.g., customizes borders, menu bars, and product displays) and maintains other system web pages.

A general overview of how a user may search for scholarships through an embodiment of the system is presented by way of illustrative non-limiting example. Once the system database is set up and operational, universities and other institutions may submit scholarship entries along with limitations on their availability. For example, a private institution may submit a scholarship that is only available to students at that school, and specify that the scholarship only appear in search results that are obtained through that school's web site. Further, a public institution may submit a scholarship that is only available to students at that school, but may be included in search results obtained from the web site of any public school in the state. Finally, a benevolent organization may submit a scholarship that is available to students at any school and place no limits on its availability from searches.

Consider now a student that has a preexisting account with the system. If that student conducts a search through a national web site (e.g., the main web site of the system), the search results will include that benevolent organization's scholarship (assuming that the student's search criteria match) yet omit both the private school's scholarship and the public school's scholarship that might otherwise match the search criteria. If the same student searches through the private school's web site, the student's search results will (assuming matching search criteria) include both the private school's and the benevolent organization's scholarships, but not the state school's scholarship. Finally, if the student searches through a web site of a public school in the same state as the above state school, his search results will include both the state school's and the benevolent institution's scholarships (assuming matching search criteria), but not that of the private school. Thus, the scope of the student's search is at least partially dependent on the selection of the web page through which he searches.

As used herein, the term “student” may mean current or potential student. A search may be for any, or a combination, of scholarships, grants, awards, loans, and financial aid. The particular process flows discussed herein are not limiting. Cancellation of screens may result in the browser being directed to various locations; the selections discussed herein are not limiting.

On optional feature of the above embodiment is to organize the search results with priority to local entries over national entries. Other types of prioritization could also be established.

The above-embodiments are directed to scholarship and financial aid information. However, use of the methodology and structure may be employed in other environments within the scope and spirit of the invention.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. An on-line method of matching students with scholarships the method comprising:
providing a pool of databases comprising one or more databases, the pool of databases being logically partitioned into at least a national section and at least one local section, the pool of databases containing entries from a plurality of customers;
receiving, through a computer network, a first request formed by a first customer to insert an entry identifying a scholarship into one or more of the national section and a first local section;
inserting the entry into the pool of databases, the entry being inserted into the pool of databases consistent with the first request;
receiving a second request to search for scholarship information, the second request sent by a user through a web site associated with the first customer; and
searching for scholarship information consistent with the second request, a scope of said searching having a dependency on at least the web site associated with the first customer, the dependency resulting in the scope of said searching including the first local section associated with the first customer;
receiving a third request to search for scholarship information, the third request sent by the user through a web site associated with a second customer;
searching for scholarship information consistent with the third request, a scope of said searching having a dependency on at least the web site associated with the second customer, the dependency resulting in the scope of said searching excluding the first local section associated with the first customer;
whereby said searching for scholarship information consistent with said second request produces any match between a student and scholarship information.

2. The method of claim 1, further comprising the scope of the search including national scholarships.

3. The method of claim 1, further comprising gathering student information.

4. The method of claim 1, wherein the scholarship comprises one of a scholarship, a grant, an award, a loan, and financial aid.

5. The method of claim 1, wherein said searching for a scholarship consistent with the third request comprises searching the national section of the pool of databases.

6. An on-line method of matching students with scholarships, the method comprising:
providing a first pool of databases comprising one or more databases, the first pool of databases containing entries from a plurality of sources, each entry being associated with a specific source and identifying a scholarship;
receiving, from a plurality of users, a plurality of requests to search for a scholarship, each request formed by a user, each request associated with a student and comprising personal information associated with that student;
searching, with respect to each request, for scholarship information consistent with said receiving;
storing, in a second pool of databases comprising one or more databases, personal information specific to each student associated with a request; and
providing demographic information derived from the second pool of databases;
wherein said searching produces any match between a student associated with each request and scholarship information, and whereby said providing results in a recipient receiving reliable demographic information; and
wherein each request is formed on a web page hosted by an entity and a scope of said searching is at least partially dependent on stipulations of the entity.

7. The method of claim 6, wherein the scholarship comprises one of a scholarship, a grant, an award, a loan, and financial aid.

8. The method of claim 6, wherein said providing demographic data comprises providing demographic data to a third party.

9. An on-line method of matching students with scholarships, the method comprising:
storing scholarship data comprising national scholarship data and local scholarship data;
receiving a first search request from a user, the first search request comprising a first search criteria;
searching, in association with a first web site, the scholarship data based on at least the first search criteria;
returning first search results, through the first web site, the first search results including matches between the first search criteria and the national scholarship data, and omitting matches between the first search criteria and the local scholarship data;
providing a customer-specific web site access to the scholarship data;
receiving a second search request, from the customer-specific website, the second search request comprising a second search criteria;
searching the scholarship data based on at least the second search criteria; and
returning second search results via the customer-specific web site, the second search results including matches between the second search criteria and the national data, matches between the second search criteria and the local data as authorized by an associated at least one customer, and omitting matches between the second search criteria and the local data that are unauthorized by an associated at least one customer.

10. The method of claim 9, further comprising prioritizing match with the local scholarship data ahead of matches with the national scholarship data.

11. The method of claim 9, wherein the first search criteria and second search criteria are the same, and the first search results are different from the second search results.

12. The method of claim 9, wherein the customer-specific website comprises a plurality of customer-specific websites.

13. The method of claim 9, wherein the scholarship data comprises at least one of a scholarship, a grant, an award, a loan, and financial aid.

14. A system for matching students with scholarships, the system comprising:
scholarship data comprising national scholarship data and local scholarship data;
a first web site configured to provide a first search request from a first user, the first search request comprising a first search criteria;
a customer-specific web site configured to provide a second search request from a second user, the second search request comprising a second search criteria;
a search engine configured receive the first search request, to search said scholarship data based on the first search criteria, and to return first search results through the first web site, the first search results including matches between the first search criteria and the national scholarship data, and omitting matches between the first search criteria and the local data; and
said search engine further configured to receive the second search request, to search said scholarship data based on the second search criteria, and to return second search results through the customer-specific web site, the second search results including matches between the second search criteria and the national data, matches between the second search criteria and the local data as authorized by an associated at least one customer, and omitting matches between the second search criteria and the local data that are unauthorized by an associated at least one customer.

15. The system of claim 14, wherein the first search criteria and second search criteria are the same, and the first search results are different from the second search results.

16. The system of claim 14, wherein the customer-specific website comprises a plurality of customer-specific websites.

17. The system of claim 14, wherein the scholarship data comprises at least one of a scholarship, a grant, an award, a loan, and financial aid.
